(19) United States
(12) Patent Application Publication
(10) Pub. No.: US 2005/0041159 A1
(43) Pub. Date: Feb. 24, 2005

(54) Editing device and editing method

(76) Inventors: Nobuo Nakamura, Kanagawa (JP); Fumio Shimizu, Kanagawa (JP); Toshihiro Shiraishi, Kanagawa (JP); Hiroshi Yamauchi, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/863,232

(22) Filed: Jun. 9, 2004

(30) Foreign Application Priority Data
Jun. 13, 2003 (JP) P2003-170123

(51) Int. Cl. H04N 7/01; H04N 5/93

(52) U.S. Cl. 348/722; 348/445; 386/52

(57) ABSTRACT

An editing method for producing edited images by connecting a first material image and a second material image in response to an external operation is adapted to conducting a transition effect producing process of passing from the first material image to the second material image and shifting the starting point of the transition effect producing process depending on the video format when conducting the transition effect producing process. With this arrangement, the editing method can prevent the starting point of a transition effect from being displaced when the video format is converted for the outcome of an editing operation involving a transition effect producing process.

### BACKGROUND OF THE INVENTION

1. Field of the Invention

This invention relates to an editing device and an editing method and, in particular, is suitably applied to an on-air system of a television broadcasting station.

2. Related Background Art

Television broadcastings of high definition television (HDTV) systems that offer high quality images and sounds, involving the use of wide display screens, have been provided typically by way of broadcasting satellites in addition to television broadcastings of standard television systems such as the National Television System Committee (NTSC) system.

The genres of television programs that are broadcast by high definition television systems are increasing to cope with television programs broadcast by standard television systems. As a matter of fact, the video and audio contents of a television program are often broadcast both by a high definition television system and by a standard television system.

When the video and audio contents of a television program are broadcast both by a high definition television system and by a standard television system, they are generally produced in an integrated manner. For example, when the video contents of a television program produced for a high definition television system are to be used for a standard television system, the images of the television program for the high definition television system are down-converted into images for the standard television system. When, on the other hand, the video contents of a television program produced for a standard television system are to be used for a high definition television system, the images of the television program for the standard television system are up-converted into images for the high definition television system (see, inter alia, Patent Document 1: Japanese Patent Application Laid-Open Publication No. 2000-30862 (pp. 3-4, FIG. 1)).

However, when a television program is to be produced for both a high definition television system and a standard television system in an integrated manner and the audio and video contents of the television program need to be edited, there can be occasions where the outcome of an editing operation carried out for the high definition television system cannot be reflected straightly to the standard television system because of the difference of number of scanning lines and the difference of aspect ratio between the two television systems.

For example, when an image of a television program for the standard television system is to be obtained by cutting the corresponding image for the high definition television system at the opposite lateral sides and a process for producing a transition effect such as a page-turning effect or a wiping effect is to be conducted on the video and audio contents of the television program, there arises a problem that the starting point of the effect producing process on the image for the standard television system is displaced relative to the corresponding image for the high definition television system only at the parts of the image where the image cutting operation is conducted.

More specifically, when an image for the high definition television system is subjected to a page-turning action that starts from the lower left corner of the display screen, it can start from a midway position on the left edge of the display screen in the corresponding image for the standard television system. When an image for the high definition television system is subjected to a wiping action that starts from the left edge of the display screen, the starting time of the wiping action of the corresponding image for the standard television system can be delayed by a time period corresponding to the cut part of the image. In both cases, viewers of the program in the standard television system may have a strange feeling.

To avoid the same contents from being displayed differently as a result of editing operation depending on the television system, it is conventionally necessary to carry out the same editing operation separately on the image for the high definition television system and the corresponding image for the standard television system.

Therefore, when the video and audio contents of a television program are produced both for a high definition television system and for a standard television system in an integrated manner, the same editing operation needs to be carried out for each of the television systems in order to obtain the same outcome for the two television systems. It is cumbersome to carry out the same editing operation repeatedly.

### SUMMARY OF THE INVENTION

In view of the foregoing, an object of this invention is to provide an editing device and an editing method that can remarkably improve the efficiency of editing operation.

According to the invention, the above identified problem is dissolved by providing an editing device for producing edited images by connecting a first material image and a second material image in response to an external operation, the device comprising: a special effect processing means for conducting a transition effect producing process of passing from the first material image to the second material image; and a shifting means for shifting the starting point of the transition effect producing process depending on the video format when conducting the transition effect producing process.

With this arrangement, the editing device can prevent the starting point of a transition effect from being displaced when the video format is converted for the outcome of an editing operation involving a transition effect producing process. Therefore, it is possible to avoid the cumbersomeness of being necessary to carry out the same editing operation repeatedly.

According to the invention, there is provided an editing method for producing edited images by connecting a first material image and a second material image in response to an external operation, the method comprising, shifting the starting point of a transition effect producing process depending on the video format when conducting the transition effect producing process of passing from the first material image to the second material image.

With this arrangement, the editing method can prevent the starting point of a transition effect from being displaced when the video format is converted for the outcome of an editing operation involving a transition effect producing process. Therefore, it is possible to avoid the cumbersomeness of being necessary to carry out the same editing operation repeatedly.

Thus, according to the invention, there is provided an editing device for producing edited images by connecting a first material image and a second material image in response to an external operation, the device comprising a special effect processing means for conducting a transition effect producing process of passing from the first material image to the second material image and a shifting means for shifting the starting point of the transition effect producing process depending on the video format when conducting the transition effect producing process. Therefore, the editing device can prevent the starting point of a transition effect from being displaced when the video format is converted for the outcome of an editing operation involving a transition effect producing process and hence it is possible to avoid the cumbersomeness of being necessary to carry out the same editing operation repeatedly so as to remarkably improve the efficiency of editing operation.

Additionally, according to the invention, there is provided an editing method for producing edited images by connecting a first material image and a second material image in response to an external operation, the method comprising, shifting the starting point of a transition effect producing process depending on the video format when conducting the transition effect producing process of passing from the first material image to the second material image. Therefore, the editing method can prevent the starting point of a transition effect from being displaced when the video format is converted for the outcome of an editing operation involving a transition effect producing process and hence it is possible to avoid the cumbersomeness of being necessary to carry out the same editing operation repeatedly so as to remarkably improve the efficiency of editing operation.

The nature, principle and utility of the invention will become more apparent from the following detailed description when read in conjunction with the accompanying drawings in which like parts are designated by like reference numerals or characters.

### BRIEF DESCRIPTION OF THE DRAWINGS

In the accompanying drawings:

FIG. 1 is a schematic block diagram of an on-air system to which an embodiment of the invention is applicable, showing the entire configuration thereof;

FIG. 2 is a schematic block diagram of the editing terminal unit of FIG. 1;

FIGS. 3A to 3C are schematic plan views of a video image on a display screen, illustrating how a page-turning action progress;

FIG. 4 is a schematic plan view of a video image on a display screen, illustrating a clip explorer window;

FIG. 5 is a schematic plan view of a video image on a display screen, illustrating a VFL preparing image;

FIG. 6 is a schematic plan view of another video image on a display screen, also illustrating a VFL preparing image;

FIG. 7 is a schematic plan view of still another video image on a display screen, also illustrating a VFL preparing image;

FIG. 8 is a schematic plan view of still another video image on a display screen, illustrating an FX explorer window;

FIG. 9 is a schematic plan view of still another video image on a display screen, illustrating an audio explorer window; and

FIG. 10 is a flow chart of the sequence of operation of a transition effect producing process.

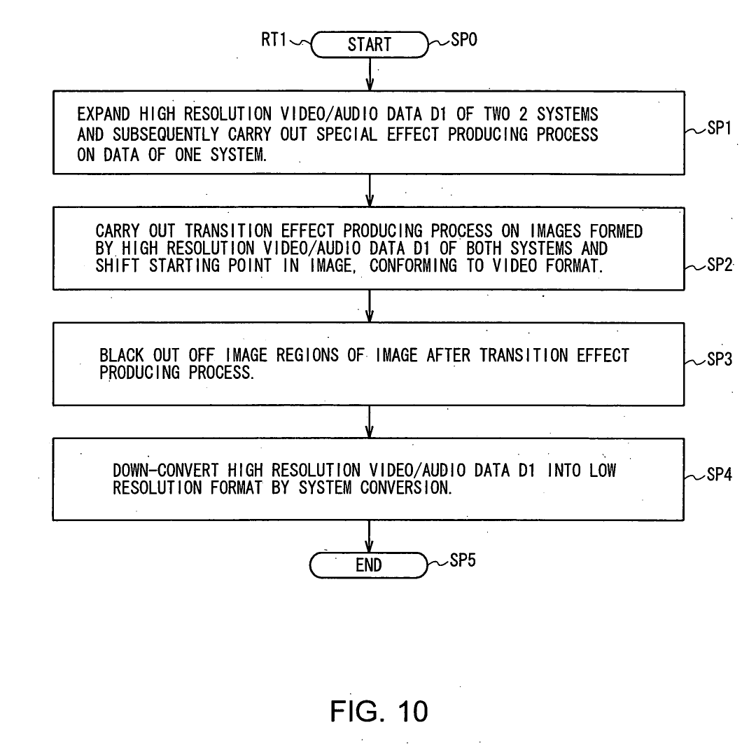

### DESCRIPTION OF THE PREFERRED EMBODIMENT

Preferred embodiment of this invention will be described with reference to the accompanying drawing:

(1) Configuration of an On-Air System to Which the Embodiment is Applicable.

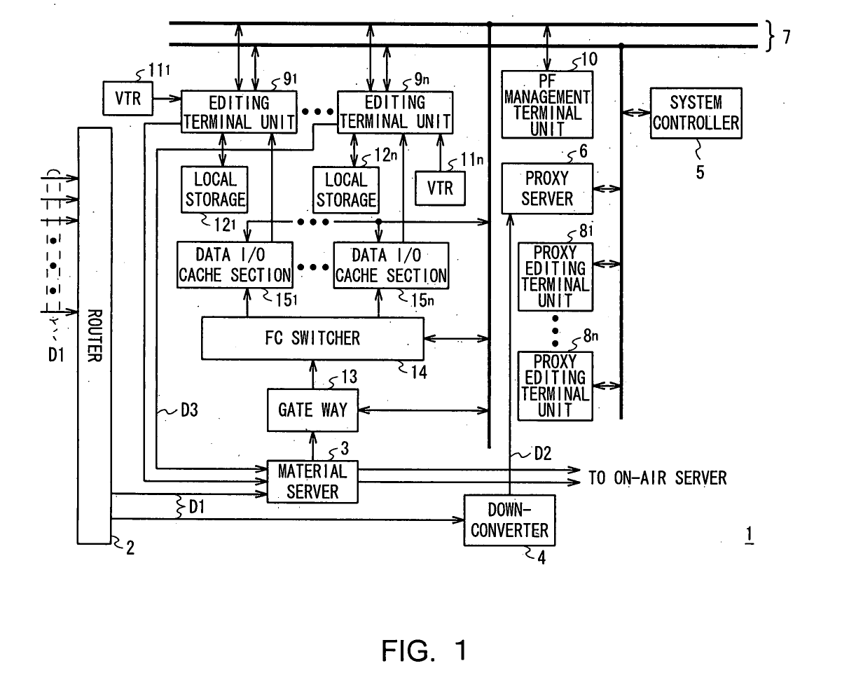

Referring to FIG. 1, reference symbol 1 generally denotes an on-air system of a television broadcasting station to which the embodiment is applicable. Video and audio data (to be referred to as high resolution video/audio data hereinafter) D1 in the HDCAM format (trade name: available from Sony Corporation) transferred from a camera shooting site by way of a satellite communication line or the like or reproduced by a video tape recorder (not shown) with a resolution of about 140 Mbps are input to material server 3 and down-converter 4 by way of a router 2.

The material server 3 is a large capacity audio/video (A/V) server comprising a recording/reproducing section formed by a plurality of redundant arrays of independent disks (RAID). It is adapted to form a file of a series of high resolution video/audio data D1 supplied by way of the router 2.

The down converter 4 down-converts the supplied high resolution video/audio data D1 into data with a resolution of about 8 Mbps and subjects them to compression coding in the Motion Picture Experts Group (MPEG) format. The obtained low resolution video and audio data (to be referred to as low resolution video/audio data hereinafter) D2 is then fed to a proxy server 6.

Like the material server 3, the proxy server 6 is an AV server comprising a recording/reproducing section formed by a plurality of RAIDs. It is adapted to form a file of a series of low resolution video/audio data D2 supplied from the down converter 4.

In this way, the on-air system 1 records the low resolution video/audio material (to be referred to as clip hereinafter) whose contents are the same as those of the clip recorded in the material server 3.

The low resolution video/audio data D2 of each of the clips stored in the proxy server 6 can be read out by means of proxy editing terminal unit 8₁ through 8ₙ and editing terminal unit 9₁ through 9ₙ connected to the proxy server 6 by way of Ethernet™ 7. It is possible to prepare a list (to be referred to as virtual file list (VFL) hereinafter) that defines an editing operation for producing images/sounds (to be referred to as edited images/sounds hereinafter) by way of processing and editing of connecting some of the clips stored in the material server 3, using the proxy editing terminal units 8₁ through 8ₙ and the editing terminal unit 9₁ through 9ₙ.

Actually, when a clip is selected out of the clips recorded in the proxy server 6 and an instruction for replaying the clip is issued by an operator in a VFL preparation mode to start a dedicated piece of software, the proxy editing terminal units 8₁ through 8ₙ access the system controller 5 by way of Ethernet™ 7 and control the proxy server 6 by way of the system controller 5 so as to drive the proxy server 6 to sequentially read out the low resolution video/audio data D2 of the clip.

The proxy editing terminal units 8₁ through 8ₙ decode the low resolution video/audio data D2 read out from the proxy server 6 and display the images obtained on the basis of the base band video/audio data. Then, the operator can prepare a VFL for editing only cuttings, visually confirming the images being displayed on one or more than one display screens.

Additionally, the operator can transfer the data of the VFL prepared in this way (to be referred to as VFL data hereinafter) from the proxy editing terminal units 8₁ through 8ₙ to a project file management terminal unit 10 by way of Ethernet™ 7. The transferred VFL data are stored in and managed by the project file management terminal unit 10.

On the other hand, the editing terminal unit 9₁ through 9ₙ are non-linear editing devices in which respective video boards are mounted so as to be able to perform video special effect operations on any of the high resolution video/audio data D1 stored in the material server 3 on a real time basis. As in the case of the proxy editing terminal units 8₁ through 8ₙ, when a clip is selected and an instruction for replaying a clip is issued by the operator in a VFL preparation mode to start a dedicated piece of software, the proxy editing terminal units 8₁ through 8ₙ control the proxy server 6 by way of the system controller 5 so as to drive the proxy server 6 to display the low resolution images of the clip on one or more than one display screens. Then, the operator can prepare a final VFL that contains instructions for special effect operations and sound mixing operations, visually confirming the images being displayed on the one or more than one display screens.

The terminal units 9₁ through 9ₙ are respectively connected to video tape recorders 11₁ through 11ₙ and local storages 12₁ through 12ₙ which are typically hard disks. Therefore, it is possible to pick up images/sounds recorded on a video tape or the like and store them in the local storages 12₁ through 12ₙ by way of the video tape recorders 11₁ through 11ₙ as clips, which may be used for subsequent editing operations.

In the course of preparing a VFL, the editing terminal units 9₁ through 9ₙ may access the system controller 5 by way of Ethernet™ 7 in response to an operation of the operator and control the material server 3 by way of the system controller 5 to read out in advance the high resolution video/audio data D1 that may be necessary when producing edited images/sounds on the basis of the VFL.

The high resolution video/audio data D1 read out from the material server 3 are then subjected to format conversion by way of a gate way 13 so as to use a predetermined format. Subsequently, they are sent to data I/O cache sections 15₁ through 15ₙ that are semiconductor memories typically having a memory capacity of about 180 giga-bytes by way of a fiber channel switcher 14 and stored and held there.

When the operator's operation of preparing the VFL ends and an instruction for execution of the VFL is entered, the editing terminal units 9₁ through 9ₙ read out the high resolution video/audio data D1 as specified in the VFL from the data I/O cache sections 15₁ through 15ₙ and, if necessary, carry out special effect operations and sound mixing operations on the high resolution video/audio data D1. Then, the data of the edited images/sounds that are obtained in this way (to be referred to as edited video/audio data hereinafter) D3 are transmitted to the material server 3. As a result, a file is formed by the edited image/sound data D3 and stored in the material server 3 under the control of the system controller 5.

The edited image/sound data D3 recorded in the material server 3 are then transferred to an on-air server (not shown) in response to a corresponding operation on the part of the operator. Thereafter, they are read out according to a so-called play list prepared by the program production staff or the like for broadcasting.

In this way, the on-air system 1 is adapted to efficiently carry out a series of operations from editing video/audio data to putting on air the edited images/sounds that are obtained as a result of the editing operation.

(2) Configuration of the Editing Terminal Units 9₁ Through 9ₙ

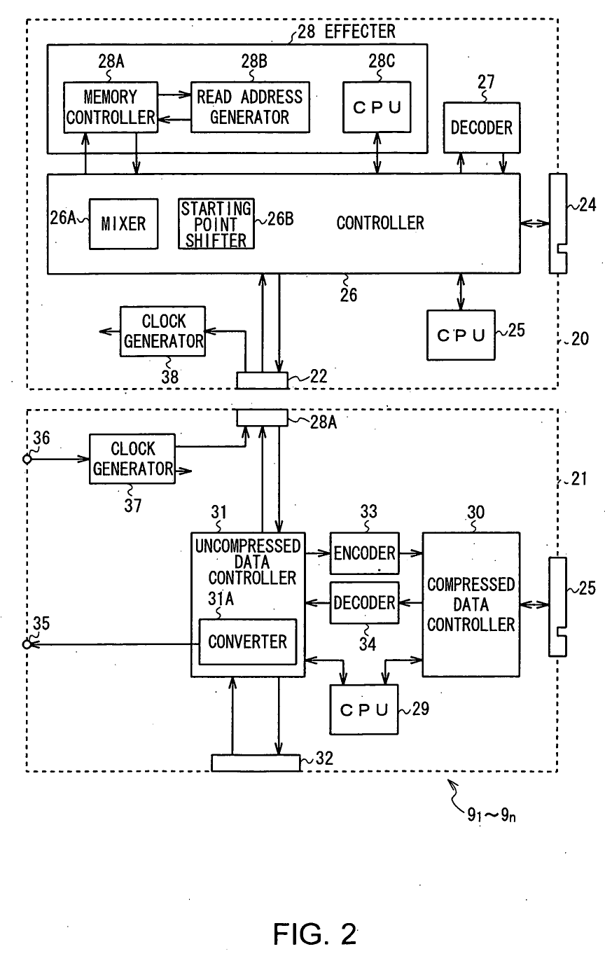

As shown in FIG. 2, first and second peripheral component interconnect (PCI) boards 20, 21 are mounted in the main body of each of the editing terminal unit 9₁ through 9ₙ for the purpose of carrying out special effect operations and interconnected by way of connectors 22, 23. Additionally, they are respectively provided with PCI connectors 24, 25 as external terminals.

The first PCI board 20 has a controller 26 that performs various control operations according to the commands from the central processing unit (CPU) 25. The controller 26 is connected to the PCI connector 24, decoder 27, effecter 28 and the connector 22.

On the other hand, the second PCI board 21 has a compressed data controller 30 and an uncompressed data controller 31 that perform various control operations according to the commands from the CPU 29. The compressed data controller 30 is connected to the PCI connector 25, while the uncompressed data controller 31 is connected to the connector 23 and port 32. An encoder 33 and a decoder 34 are arranged between the compressed data controller 30 and the uncompressed data controller 31 so that images in a high resolution format may be compressed or expanded in the HDCAM format.

The first PCI board 20 is adapted to transmit the high resolution video/audio data D1 that are compressed in the HDCAM format and supplied from the material server 3 (FIG. 1) to the decoder 27 by way of the PCI connector 24 and the controller 26. The controller 26 expands the high resolution video/audio data D1 input to the decoder 27 to restore the original base band and subsequently transmits them to the effecter 28.

The effecter 28 of the first PCI board 20 performs a color correction processing operation on the expanded high resolution video/audio data D1 and also a clip effect processing operation such as a chroma-key processing operation on the video material formed by the high resolution video/audio data D1. It then transmits the processed high resolution video/audio data D1 to the controller 26.

Actually, the effecter 28 has in the inside thereof a memory controller 28A and a read address generator 28B, which are adapted to operate according to the commands issued from the CPU 28C. The memory controller 28A generates key signals, which indicate write addresses, read addresses for the data of pixels and, when appropriate, the boundary of a scene change (e.g., a round frame that contains the succeeding scene and expands gradually in the preceding scene).

As high resolution video/audio data D1 are input from the controller 26, the memory controller 28A writes the high resolution video/audio data D1 into an external frame memory (not shown) according to the write addresses.

The read address generator 28B generates read addresses for the data of pixels by performing computing operations of additions, multiplications, conversions from orthogonal coordinates to polar coordinates and so on according to the type of special effect selected by the operator and the effect parameters of the special effect with the external memory (not shown).

At this time, when appropriate, the memory controller 28A performs an image deforming processing operation on the high resolution video/audio data D1, sequentially reading the high resolution video/audio data D1 from the external frame memory (not shown) according to the read addresses.

On the other hand, the second PCI board 21 is adapted to transmit the high resolution video/audio data D1 that are compressed in the HDCAM format and supplied from the material server 3 (FIG. 1) to the decoder 34 by way of the PCI connector 25 and the compressed data controller 30. The compressed data controller 30 expands the high resolution video/audio data D1 input to the decoder 34 to restore the original base band and subsequently transmits them to the uncompressed data controller 31. The uncompressed data controller 31 transmits the high resolution video/audio data D1 that are subjected to an expanding operation to the controller 26 by way of the connector 23 and the connector 22 in the first PCI board 20.

Thereafter, the controller 26 has an internal mixer 26A and is adapted to conduct a transition effect producing process on the images formed by the high resolution video/audio data D1 of two sequences that are subjected to an expanding operation by way of the first and second PCI connectors 24, 25. For instance, the transition effect may be a three-dimensional page-turning action of removing the overlaying image to gradually expose the underlying image.

The controller 26 has an internal starting point shifter 26B and is adapted to shift the starting point of a transition effect on the display screen depending on the video format. For example, the starting point shifter 26B of the controller 26 shifts the starting point of a transition effect by referring to the aspect ratio of 4:3 for the low resolution format from the starting point of a corresponding transition effect of an image formed according to the high resolution format by means of high resolution video/audio data D1 of two sequences that shows an aspect ratio of 16:9.

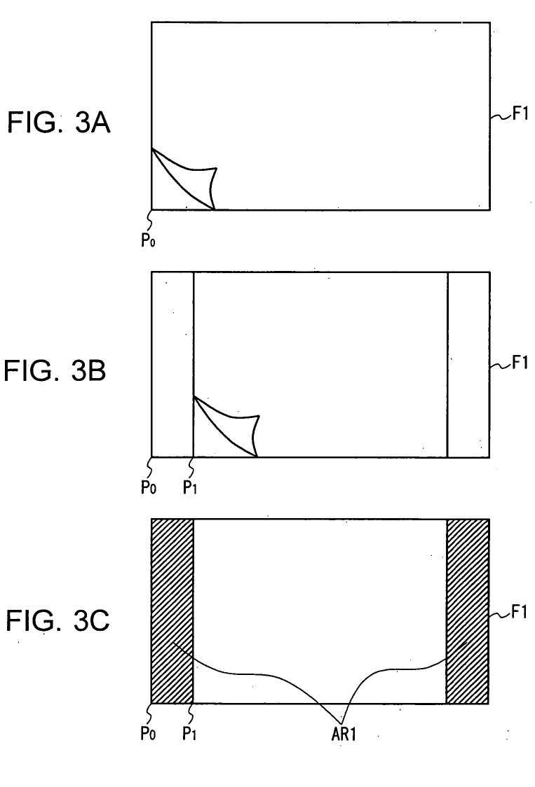

More specifically, the starting point shifter 26B of the controller 26 revises the read address of the starting point P₀ on the display screen F1 for a transition effect producing process having an aspect ratio of 16:9 as shown in FIG. 3A so as to shift it to starting point P₁ on an area of the display screen F1 having an aspect ratio of 4:3 as shown in FIG. 3B.

Then, the controller 26 blacks out the regions (to be referred to as off screen regions hereinafter) AR1 (see FIG. 3C) of the image formed by the high resolution video/audio data subjected to the transition effect producing process and displayed on the display screen having the aspect ratio of 16:9 that are located at the opposite lateral sides and will go out from a display screen having the aspect ratio of 4:3.

The high resolution video/audio data D1 for the image obtained by blacking out the off screen regions AR1 by the controller 26 are then transmitted to the uncompressed data controller 31 by way of the connector 22 and the connector 23 in the second PCI board 21.

The uncompressed data controller 31 has a converter 31A for system conversion and is adapted to convert the high resolution video/audio data D1 supplied from the first PCI board 20 into low resolution video/audio data for the standard television system and subsequently transmit them to an external display (not shown) by way of the connector 35.

The uncompressed data controller 31 is also adapted to compress the high resolution video/audio data D1 supplied from the first PCI board 20 in the HDCAM format by way of the encoder 33 and subsequently output them to the outside by way of the compressed data controller 30 and the PCI connector 25 without any system conversion.

A reference signal is input to clock generator 37 of the second PCI board 21 from the outside by way of input connector 36 and the clock having a predetermined frequency as generated by the clock generator 37 is supplied to the various sections of the second PCI board 21 and also to the clock generator 38 by way of the connector 23 and the connector 22 in the first PCI board 20. The clock generator 38 also generates a predetermined clock by referring to the clock obtained from the clock generator 37 and supplies it to the various sections of the first PC board 20.

(3) VFL Preparation Procedure in the Editing Terminal Units 9₁ Through 9ₙ

Now, the VFL preparation procedure-in the editing terminal units 9₁ through 9ₙ will be described below.

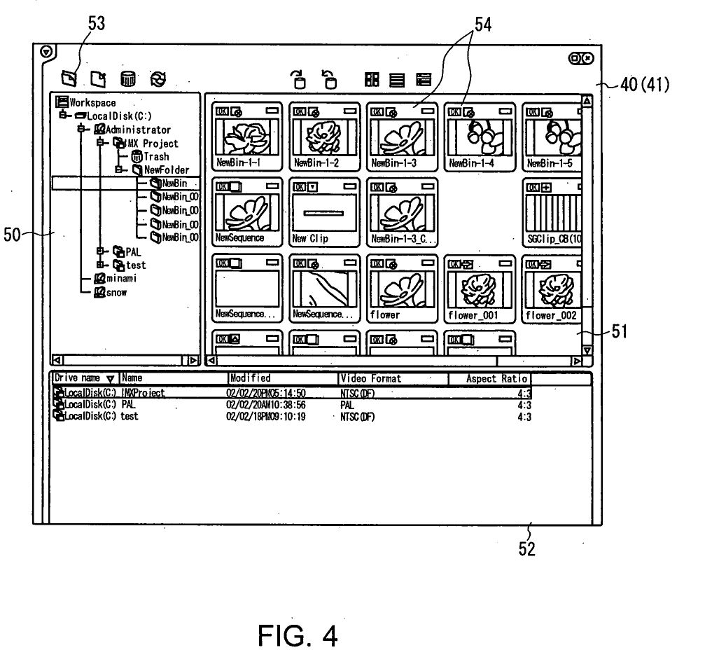

In a VFL preparation mode, the CPUs 25, 29 of each of the editing terminal units 9₁ through 9ₙ has a display (not shown) display a clip explorer window 40 as shown in FIG. 4 and a sever site explorer window 41 similar to the clip explorer window 40 in response to a predetermined operation carried out by the operator.

The clip explorer window 40 is an window for synoptically displaying some of the clips stored in the local storages 12₁ through 12ₙ and the data I/O cache sections 15₁ through 15ₙ connected respectively to the editing terminal units 9₁ through 9ₙ and includes a tree display section 50, a clip display section 51 and a clip list display section 52.

The tree display section 50 of the clip explorer window 40 displays the locations of the clips in a tree format according to the management information on the clips held in the data I/O cache sections 15₁ through 15ₙ and managed by the system controller 5 (FIG. 1) and the management information on the clips stored in the local storages 12₁ through 12ₙ and managed by the system controller 5 so as to tell which clip is stored in which drive, which holder, which file and which bin.

The clip display section 51 of the clip explorer window 40 synoptically displays all the clips stored in the bin selected in the tree display section 50. More specifically, the thumbnail images of the leading frames of the clips are displayed like so many icons with their designations. The clip list display section 52 displays the drive name of each of the clips displayed in the clip display section 51, telling where it is stored, the designation of the clip, the recording date of the clip, the video format of the clip and the length of the material of the clip in the form of a list. The icon of each of the clips displayed in the clip display section 51 is referred to as clip icon 54 hereinafter.

The server site explorer window 41 is a window for synoptically displaying a list of the clips recorded in the material server 3 and the proxy server 6 and, like the clip explorer window 40, includes a tree display section 50, a clip display section 51 and a clip list display section 52.

The tree display section 50 of the server site explorer window 41 displays the location of each of the clips recorded in the material server 3 and the proxy server 6 according to the management information on the clips managed by the system controller 5 (FIG. 1) in a tree format, whereas the clip display section 51 and the clip list display section 52 display images and information on the clips similar to those of the clip display section 51 and the clip list display section 52 of the clip explorer window 40.

When preparing a new VFL, the operator clicks new sequence preparation button 53 among a plurality of buttons being displayed in an upper part of the clip explorer window 40. Then, as a result, a clip correlated to the VFL to be prepared is prepared by the CPUs 25, 29 and the clip icon 54 of the sequence clip is displayed in the clip display section 51 of the clip explorer window 40.

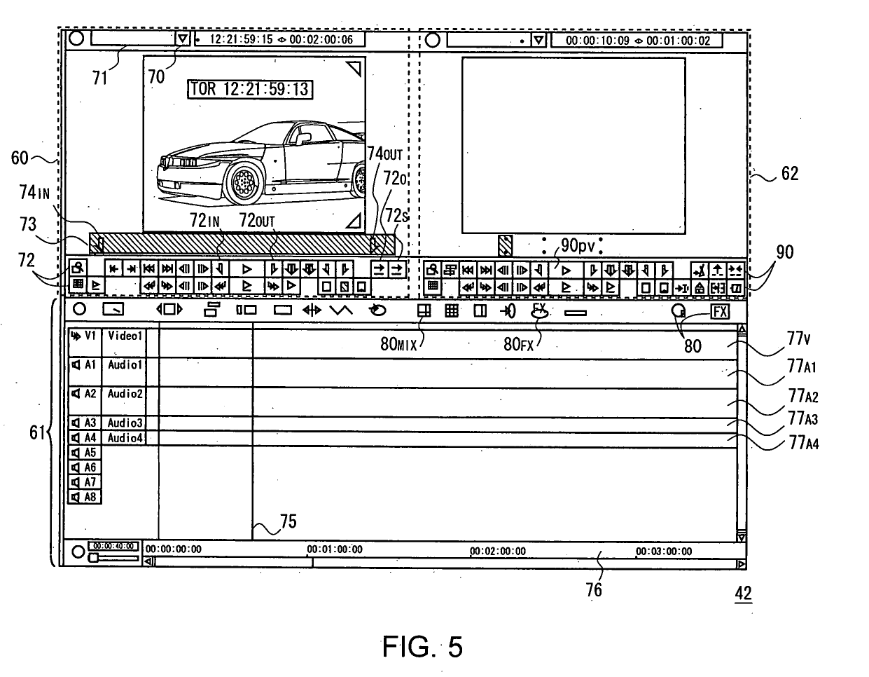

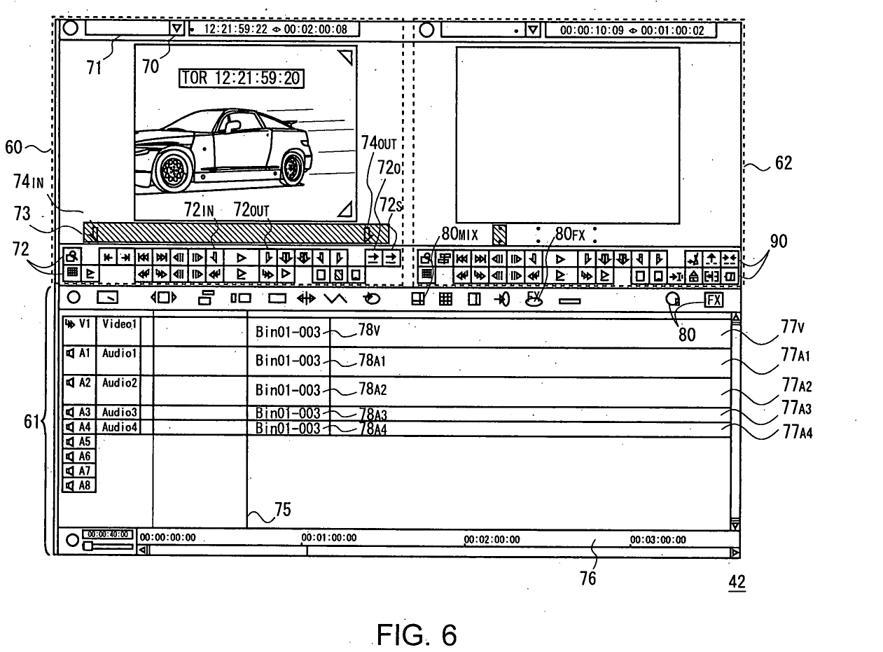

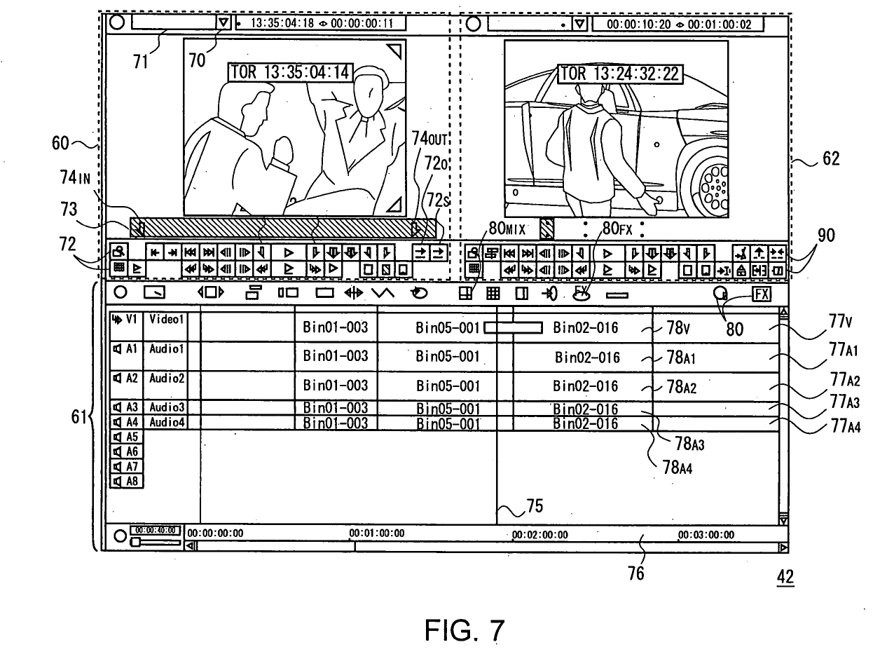

At the same time, a new VFL preparation image 42 as shown in FIGS. 5 through 7 is sequentially displayed on a display (not shown). The VFL preparation image 42 contains a source viewer section 60 to be used for cutting out desired parts of the clip as cuttings, while the operator is viewing the images of the clip, a time line section 61 to be used for defining the editing operation including how the obtained cuttings are to be arranged and, if necessary, what sort of special effect producing operation is to be conducted on each of the seams of the cuttings and a master viewer section 62 for visually confirming the outcome of the editing operation defined in the time line section 61 on actual images.

The operator can select a clip to be used for the editing operation by moving the clip icon 53 of the clip icons 53 being displayed in the clip display section 51 of the server site explorer window 41 into the source viewer section 60 of the VFL preparation image 42 by drag and drop. Thus, the operator can collectively select a plurality of clips to be used for the editing operation by repeating the above operation.

The operator also can display a menu of all the clips selected in the above described manner when he or she clicks clip selection menu display button 70 being displayed in an upper part of the source viewer section 60 in the VFL preparation image 42 and select the clips he or she wants out of the clips on the menu by clicking them on the menu. Then, the designation of the clip that is selected last is displayed in clip list box 71 and, at the same time, the image of the leading frame of the clip is displayed in the source viewer section 60.

In the VFL preparation image 42, the image of the clip being displayed on the source viewer section 60 that is formed by the corresponding low resolution video/audio data D2 recorded in the proxy server 6 (FIG. 1) can be moved normally or frame by frame either forwardly or backwardly by operating the corresponding one of the various command buttons 72 being displayed in a lower part of the source viewer section 60.

More specifically, as the command button 72 for normal replay or for frame by frame forward or backward replay is operated, the CPUs 25, 29 output the low resolution video/audio data D2 of the corresponding image/sound of the clip by controlling the proxy server 6 by way of the system controller 5. As a result, an image formed by the low resolution video/audio data D2 is displayed on the source viewer section 60 for normal replay or frame by frame forward or backward replay.

Thus, the operator can specify the starting point (in point) and the terminating point (out point) of the images/sounds to be used as cutting from the clip by operating a mark in button 72_{IN} and a mark out button 72_{OUY} of the command buttons 72, while viewing the image of the clip being displayed on the source viewer section 60.

When the in point and the out point are specified in this way, a mark indicating the in point (to be referred to as in point mark hereinafter) 74_{IN} and a mark indicating the out point (to be referred to as out point mark hereinafter) 74_{OUT} are displayed at the positions respectively corresponding to the in point and the out point of a position bar 73 being displayed in a lower part of the displayed image in the source viewer section 60 (at the positions respectively corresponding to the in point and the out point when the length of the position bar 73 is assumed to be the length of the material to be more accurate).

On the other hand, the operator can prepare a VFL by following the procedure as described below, using the images/sounds to be used as cutting of the clip that are specified in the above described manner.

Firstly, the operator determines the part of the images/sounds of the clip to be used as cutting and then moves a play line 75 being displayed in the time line section 61 to a desired position by operating the mouse, referring to a time scale 76 being displayed in a lower part of the time line section 61. Then, the operator clicks an overwrite button 72_{O} or a splice button 72_{S} out of the various command buttons 72 being displayed in a lower part of the source viewer section 60.

Then, as a result, a colored region 78_{V} having a length corresponding to the length of the material for the selected images/sounds is displayed on a video track 77_{V} of the time line section 61 with the play line 75 taking the leading edge so as to appear as if it were overwritten when the overwrite button 72_{O} is clicked and inserted when the splice button 72_{S} is clicked.

Additionally, if sounds accompanies the selected images/sounds, colored regions 78_{A1} through 78_{A4} having a length same as that of the colored region 78_{V} on the video track 77_{V} are displayed respectively on the audio tracks 77_{A1} through 77_{A4}, or so many audio tracks to be used out of the audio tracks 77_{A1} through 77_{A4}, arranged under the video track 77_{V}, with the play line 75 taking the leading edge.

The CPUs 25, 29 notify the system controller 5 of the command that corresponds to the operation of the operator. As a result, the high resolution video/audio data D1 for the part of the images/sounds of the clip are read out from the material server 3 (FIG. 1) at the side of the in point and also at the side of the out point with a safety margin of several seconds under the control of the system controller 5 and transmitted to the data I/O cache sections 15₁ through 15ₙ of the editing terminal units 9₁ through 9ₙ by way of gate way 13 (FIG. 1) and FC switcher 14 (FIG. 1) and stored there.

If the operator wants to output sounds other than the sounds that accompany the images of the selected part of the clip when replaying the edited images and sounds, the operator clicks the clip selection menu display button 70 and selects the sound clip that has been registered in advance out of the displayed clip list. Then, the operator moves the play line 75 of the time line section 61 to a desired position and specifies the audio tracks 77_{A1} through 77_{A4} that need to be used. Thereafter, the operator clicks either the overwrite button 72_{O} or the splice button 72_{S}.

In this case again, colored regions 78_{A1} through 78_{A4} having a length corresponding to the length of the material for the selected sounds of the clip are displayed respectively on the audio tracks 77_{A1} through 77_{A4} with the play line 75 taking the leading edge. At the same time, if the clip is recorded in the material server 3, audio data are read out from the material server 3 and stored in the data I/O cache sections 15₁ through 15ₙ.

Then, the operator repeats the operation of selecting images/sounds, or a part of a clip (producing a cutting), pasting up the images/sounds to the time line section 61 (displaying colored regions 78_{V} and 78_{A1} through 78_{A4} respectively on the video track 77_{V} and the corresponding audio tracks 77_{A1} through 77_{A4}) to extend the colored regions 78_{V} and 78_{A1} through 78_{A4} respectively on the video track 77_{V} and the corresponding audio tracks 77_{A1} through 77_{A4} until they get to the intended time on the time scale 76, starting from the leading edge (“00:00, 00:00”) on the time scale 76.

It will be appreciated that colored regions 78_{V} and 78_{A1} through 78_{A4} are displayed respectively on the video track 77_{V} and the corresponding audio tracks 77_{A1} through 77_{A4} of the time line section 61 means that the image and the sound of the cutting respectively corresponding to a selected position on the colored regions 78_{V} and 78_{A1} through 78_{A4} are output at the time indicated by the time scale 76 at the position when the edited images/sounds are replayed. Thus, it is possible to prepare a VFL that defines the sequence and the contents of images/sounds that are output as edited images/sounds.

The number of video tracks and that of audio tracks that can be displayed in the time line section 61 may be selected freely. When a number of video track are displayed and cuttings are pasted up to them at a time on the time scale 76, images are overlapped there to produce edited images as a result of the video editing operation. Similarly, when a number of audio tracks are displayed and cuttings are pasted up to them at a time on the time scale 76, sounds are overlapped there to produce an edited sound as a result of the audio editing operation.

When preparing a VFL in a manner as described above, if the operator wants to produce a special effect at the time when the first cutting is switched to the second cutting to make the second cutting succeeds the first cutting without discontinuity, the operator can define the intended video special effect, following the procedure as described below.

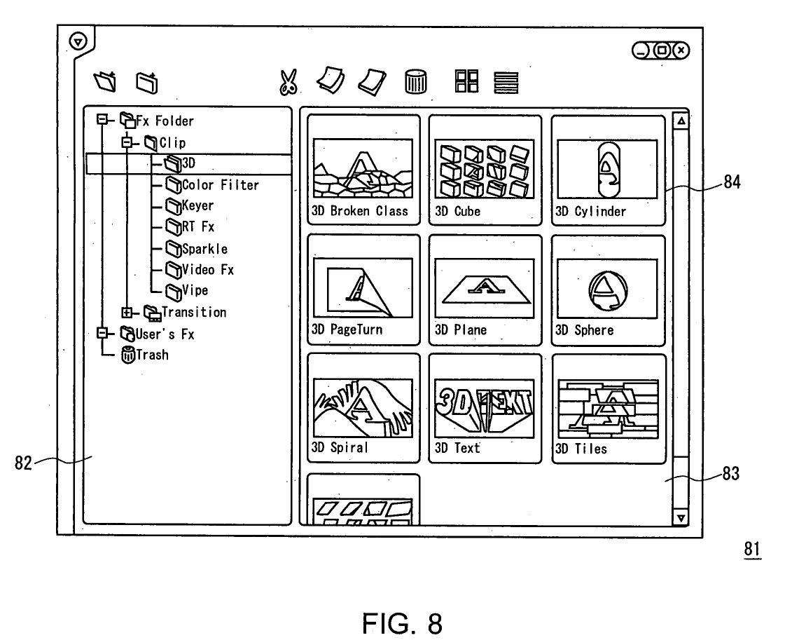

Firstly, the operator pastes up the preceding first cutting and the succeeding second cutting to the video track 77_{V} so that they are connected continuously on position bar 96 and subsequently click FX explorer button 80_{FX} out of the various buttons 80 being displayed in an upper part of the time line section 61. As a result, the operator can open an window (to be referred to as FX explorer window hereinafter) 81 where the various special effects that can be produced by means of the editing terminal units 9₁ through 9ₙ are displayed in tree display section 82 in a tree format, while images of the special effects are displayed in icon display section 83 like so many icons as shown in FIG. 8.

Thereafter, the operator selects the icon for the intended special effect out of the icons (to be referred to as special effect icons hereinafter) 84 being displayed in the icon display section 83 of the FX explorer window 81 by drag and drop and pastes up it to the spot on the video track 77_{V} of the VFL preparation image 42 where the first cutting is switched to the second cutting.

Then, as a result, a special effect producing process that corresponds to the special effect icon pasted up to the spot where the first cutting is switched to the second cutting is carried out in an operation of producing edited images.

When preparing the VFL, if the operator wants to carry out a sound mixing process on the cuttings pasted up to any of the audio tracks 77_{A1} through 77_{A4}, the operator can define the sound mixing process, following the procedure described below.

Firstly, the operator moves the play line 75 being displayed in the time line section 61 of the VFL preparation image 42 onto the any of the colored regions 78_{A1} through 78_{A4} that correspond to the cuttings to be used for the sound mixing operation in the cuttings pasted up to the audio tracks 77_{A1} through 77_{A4} and then clicks audio mixer button 80_{MIX} out of the plurality of buttons being displayed in an upper part of the time line section 61.

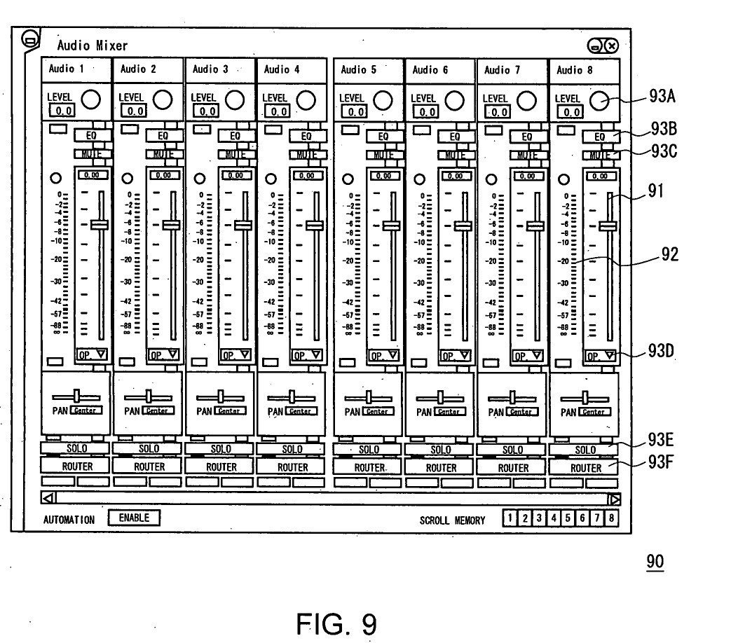

As a result, an audio mixer window 90 containing volume controls 91, level meters 92 and various selection buttons 93A through 93F that correspond respectively to the audio tracks 77_{A1} through 77_{A4} of the time line section 61 in the VFL preparation image 42 is opened as shown in FIG. 9.

Thereafter, the operator operates any of the volume controls 91 and the selection buttons 93A through 93F in the audio mixer window 90 that correspond to the intended ones of the audio tracks 77_{A1} through 77_{A4} of the time line section 61 in the VFL preparation image 42, viewing the related level meters 92.

Then, as a result, the defined sound mixing process using the sound data of any of the cuttings pasted up to the audio tracks 77_{A1} through 77_{A4} is carried out as the cuttings are replayed in an operation of producing edited images.

While or after preparing the VFL, the operator can replay and display edited high resolution images in master viewer section 62 of the VFL preparation image 42 in an ordinary replay mode, starting from the part of the images/sounds that corresponds to the play line 75 after moving the play line 75 in the time line section 61 to an intended position and subsequently clicking preview button 90_{PV} out of the plurality of command buttons 90 being displayed in a lower part of the master viewer section 62.

Actually, as the preview button 90_{PV} is operated, the CPUs 25, 29 control the controller 26, the compressed data controller 30 and uncompressed data controller 31 (FIG. 2) to have them read the high resolution video/audio data D1 for the corresponding images/sounds that are stored in and held by the data I/O cache sections 15₁ through 15ₙ and, if necessary, carry out a video special effect producing process and a sound mixing process on the high resolution video/audio data D1.

As a result, edited high resolution video/audio data are generated with or without a video special effect producing process and/or a sound mixing process and then the edited images formed by the edited video/audio data are replayed in the master viewer section 62 of the VFL preparation image 42, while the edited sounds are output from a speaker (not shown).

Thus, the operator can prepare the VFL or confirm the contents of the prepared VFL, previewing the outcome of the editing operation on the basis of the edited images displayed in the master viewer section 62 of the VFL preparation image 42.

After, preparing the VFL, the operator can register the product of the editing operation that is based on the VFL to the material server 3 (FIG. 1) by moving the clip icon 54 of the sequence clip of the VFL being displayed in the clip display section 51 of the clip explorer window 40 (FIG. 4) into the clip display section 51 of the server site explorer window 41 (FIG. 4) by drag and drop.

(4) Procedure of Transition Effect Producing Process

When a transition effect producing process is carried out for a page turning action, for example, the outcome of the editing operation can be straightly reflected to the down-converted low resolution video/audio data D2 by the first and second PCI boards 20, 21 of the editing terminal units 9₁ through 9ₙ (FIG. 2) by carrying out various processing operations on the original high resolution video/audio data D1 supplied from the material server 3 (FIG. 1), following the procedure of transition effect producing process RT1 as shown in FIG. 9.

In each of the editing terminal units 9₁ through 9ₙ, the first and second PCI boards 20, 21 carry out an expanding process on the externally supplied high resolution video/audio data D1 so as to conforming to the HDCAM format and subsequently only the high resolution video/audio data D1 that are subjected to the expanding process at the first PCI board 21 are further subjected to various processing operations such as color correction and clip effect at the effecter 28 (Step SP1).

Thereafter, the mixer 26A of the controller 26 of the first PCI board 20 carries out a transition effect producing process such as a process of producing a page-turning effect on the images of the two systems formed by the high resolution video/audio data D1 so as to gradually switch from one of the images (the image subjected to an expanding process and a special effect producing process at the first PCI board 20) to the other image (the image subjected to an expanding process at the second PCI board 21) (Step SP2).

At this time, if the high resolution video/audio data D1 of the two systems are for the aspect ratio of 16:9 that conforms to the high resolution format, the starting point shifter 26B of the controller 26 of the first PCI board 20 shifts the starting point of the transition effect producing process to the corresponding position for the aspect ratio of 4:3 that conforms to the low resolution format.

Then, the off screen regions that are out of the display screen of the aspect ratio of 4:3 at the opposite lateral sides of the image with the aspect ratio of 16:9 that are formed by the high resolution video/audio data D1 subjected to a transition effect producing process for the above-described starting point are blacked out (Step SP3).

Then, the uncompressed data controller 31 of the second PCI board 21 down-converts the high resolution video/audio data D1 for the images from which the off screen regions are blacked out so as to conform to the low resolution format by system conversion (Step SP4).

Thus, when the externally supplied high resolution video/audio data D1 are subjected to a transition effect producing process such as a page-turning effect producing process, the first and second PCI boards 20, 21 of the editing terminal units 9₁ through 9ₙ can prevent the starting point of the effect from being displaced due to the down-converting operation of producing corresponding low resolution video/audio data for the outcome of the editing operation.

(5) Operation and Advantages of this Embodiment

With the above-described arrangement, the editing terminal units 9₁ through 9ₙ of the on-air system 1 perform an expanding processing operation on the supplied high resolution video/audio data D1 of two systems so as to make them conform to the HDCAM format and subsequently carry out various processing operations such as color correction and clip effect and then one or more than one transition effect producing processes, which may include a page-turning effect producing process.

Then, they perform an operation on the high resolution video/audio data D1 of the two systems so as to shift the starting point of each of the transition effects in order to make it good not for the aspect ratio of 16:9 conforming to the high resolution format but for the aspect ratio of 4:3 conforming to the low resolution format. Thus, it is possible to prevent the starting point of the effect from being displaced due to the down-converting operation of producing low resolution video/audio data for the outcome of the editing operation.

As a result, when an image conforming to the low resolution format is displayed on a display screen, it is possible to eliminate the problem that a transition effect starts from somewhere in the off screen regions at the opposite lateral sides of a corresponding image with the aspect ratio of 16:9 that are conforming to the high resolution format because the transition effect is already so arranged that it starts from the right position in the image with the aspect ratio of 4:3.

Thus, with the above described arrangement, when the editing terminal units 9₁ through 9ₙ of the on-air system 1 carries out one or more than one transition effect producing processes, which may include a page-turning effect producing process, on images formed by high resolution video/audio data D1 of two systems, they perform an operation to shift the starting point of each of the transition effects in order to make it good not for the aspect ratio of 16:9 conforming to the high resolution format but for the aspect ratio of 4:3 conforming to the low resolution format. Thus, it is possible to prevent the starting point of the effect from being displaced due to the down-converting operation of producing low resolution video/audio data for the outcome of the editing operation. Therefore, it is possible to avoid the cumbersomeness of carrying out the same editing operation repeatedly and improve the efficiency of the editing operation.

(6) Other Embodiments

While the editing terminal units 9₁ through 9ₙ of the on-air system 1 as shown in FIG. 1 are used as editing devices for connecting a first material image and a second material image in response to an external operation in the above described embodiment, the present invention is by no means limited thereto and any of various editing devices having different configurations may alternatively be used for the purpose of the invention.

While the mixer 26A in the controller 26 of the first PCI board 20 is used as special effect producing means for producing a transition effect of switching from a first material image to a second material image in the above described embodiment, the present invention is by no means limited thereto and any of various special effect producing means having different configurations may alternatively be used for the purpose of the invention.

While a page turning effect is described above as transition effect, the present invention is by no means limited thereto and any other one or more than one transition effects, which may be three-dimensional or two-dimensional, may be additionally or alternatively be used for the purpose of the invention so long as they are adapted to remove a first image and gradually expose a second image.

Furthermore, while the starting point shifter 26B in the controller 26 of the first PCI board 20 is used as means for shifting the starting point of a transition effect in an image depending on the video format, the present invention is by no means limited thereto and any of various other shifting means having different configurations may alternatively be used for the purpose of the invention so long as it allows the starting point of the transition effect to be shifted according to the instruction of the operator or automatically depending on the video format.

While the shifting means is adapted to specify the address of the starting point of a transition effect in the image by referring to the aspect ratio of the image conforming to the video format in the above description, the present invention is by no means limited thereto and any of various different shifting techniques may alternatively be used to shift the starting point of the transition effect so long as the transition effect does not give a strange feeling to the viewer if the same transition effect is used for different video formats.

While there has been described in connection with the preferred embodiments of the invention, it will be obvious to those skilled in the art that various changes and modifications may be aimed, therefore, to cover in the appended claims all such change and modifications as fall within the true spirit and scope of the invention.

1. An editing device for producing edited images by connecting a first material image and a second material image in response to an external operation, said device comprising:
special effect processing means for conducting a transition effect producing process of passing from the first material image to the second material image; and
shifting means for shifting the starting point of the transition effect producing process depending on the video format when conducting the transition effect producing process.

2. The device according to claim 1, wherein
said shifting means specifies the address of said starting point in the image by referring to the aspect ratio of the image conforming to said video format.

3. An editing method for producing edited images by connecting a first material image and a second material image in response to an external operation, said method comprising:
a first step of conducting a transition effect producing process of passing from the first material image to the second material image; and
a second step of shifting the starting point of the transition effect producing process depending on the video format when conducting the transition effect producing process.

4. The method according to claim 3, wherein
the address of said starting point in the image is specified by referring to the aspect ratio of the image conforming to said video format in said second step.
